(19) United States
(12) Patent Application Publication
(10) Pub. No.: US 2009/0313013 A1
(43) Pub. Date: Dec. 17, 2009

(54) SIGN LANGUAGE CAPABLE MOBILE PHONE

(75) Inventor: QIN WEN, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/237,686

(22) Filed: Sep. 25, 2008

(30) Foreign Application Priority Data
Jun. 13, 2008 (CN) 200810302147.0

(51) Int. Cl. G10L 15/26

(52) U.S. Cl. 704/235; 704/E15.001

(57) ABSTRACT

A mobile phone includes a display, a data capturing module, and a sign language translating system. The data capturing module is configured to capture images of a user communicating with sign language. The sign language translating system is connected to the data capturing module. The sign language translating system includes a data input module and a data output module. The data input module is configured to receive and transform a text data or a speech data to a corresponding sign language image, and display the sign language image on the display, the data output module is configured to receive and transform a sign language image captured by the data capturing module to a corresponding text data or a corresponding speech data.

### BACKGROUND

1. Field of the Invention

The present invention relates to mobile phones and, more particularly, to a mobile phone that can receive sign language as input through imaging technology.

2. Description of Related Art

There may be times when it is inconvenient or not possible for a person to use text or speech via a mobile phone, such as in a noisy construction environment, or when a user is hearing and/or speech impaired. A hearing and/or speech impaired person, for example, may usually communicate with others by means of writing or through sign language. Writing a fluent conversation is difficult, and only a very small number of non-hearing impaired people can use sign language for communicating.

What is needed, therefore, is a mobile phone that can receive sign language as input through imaging technology.

### BRIEF DESCRIPTION OF THE DRAWINGS

FIG. 1 is a diagram of an embodiment of a sign language capable mobile phone; and

FIG. 2 is a schematic diagram of communicating with sign language using the mobile phone of FIG. 1.

### DETAILED DESCRIPTION OF THE EMBODIMENTS

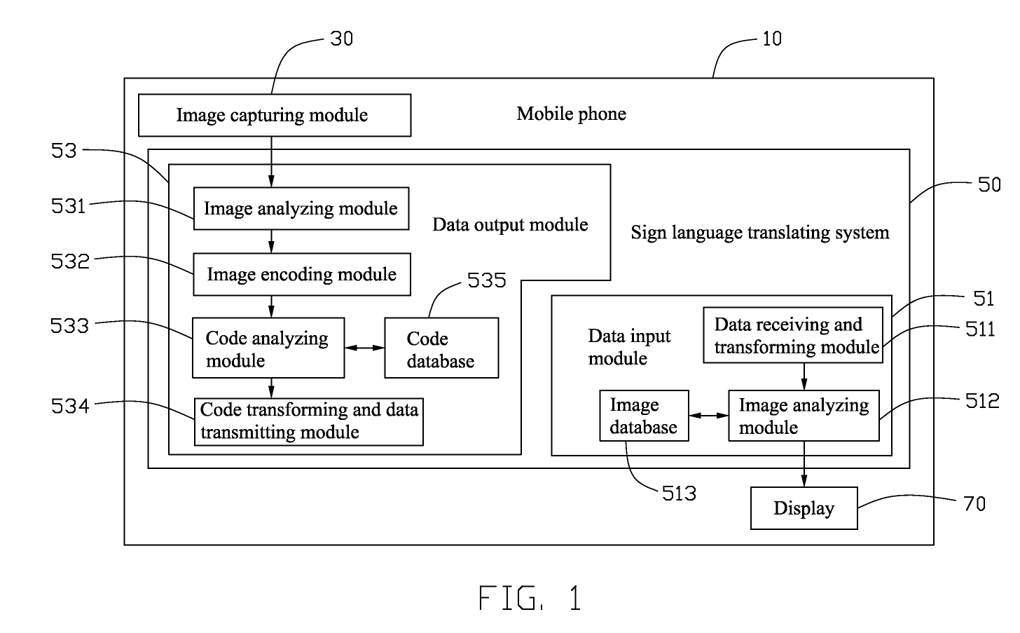

Referring to FIG. 1, an embodiment of a sign language capable mobile phone 10 includes an image capturing module 30, a sign language translating system 50, and a display 70. The image capturing module 30 is configured to capture images of a user communicating with sign language utilizing image acquisition technology. The sign language translating system 50 is configured to transform the images to text or speech data for transmission, and transform received text or speech data to corresponding sign language images for display by the display 70, so that mobile phone communication is possible for people using sign language.

The sign language translating system 50 includes a data input module 51 and a data output module 53. The data input module 51 is configured for receiving and transforming text or speech data to sign language images, and displaying those images on the display 70. The data output module 53 is configured for receiving and transforming sign language images captured by the image capturing module 30 to text or speech data. The sign language translating system 50 may be configured for any sign language that involves a user arranging some body part or parts such as a hand or hands or an object such as a wand in view of the image capturing module 30 in a sequential series of one or more pre-determined symbolic orientations that are interpretable as language.

The data output module 53 includes an image analyzing module 531, an image encoding module 532 connected to the image analyzing module 531, a code analyzing module 533 connected to the image encoding module 532, a code transforming and data transmitting module 534 connected to the code analyzing module 533, and a code database 535 connected to the code analyzing module 533. The data input module 51 includes a data receiving and transforming module 511, an image analyzing module 512 connected to the data receiving and transforming module 511, and an image database 513 connected to the image analyzing module 512. Text codes, speech codes, and image codes associated with the text and speech codes are stored in the code database 535. A plurality of sign language images and the corresponding image codes are stored in the image database 513.

The image analyzing module 531 is configured for analyzing the sign language images captured by the image capturing module 30. The image encoding module 532 is configured for encoding the analyzed images to generate a series of image codes. The code analyzing module 533 is configured for searching for the text codes or the speech codes corresponding to the image codes in the code database 535. The code transforming and data transmitting module 534 is configured for transforming the text codes to text data or the speech codes to speech data and transmitting the text or speech data to other devices capable of receiving communication from mobile phones. The data receiving and transforming module 511 is configured for receiving and transforming the text data or the speech data received from other phones to a series of image codes. The image analyzing module 512 is configured for searching the sign language images corresponding to the image codes in the image database 513, and displaying the sign language images on the display 70.

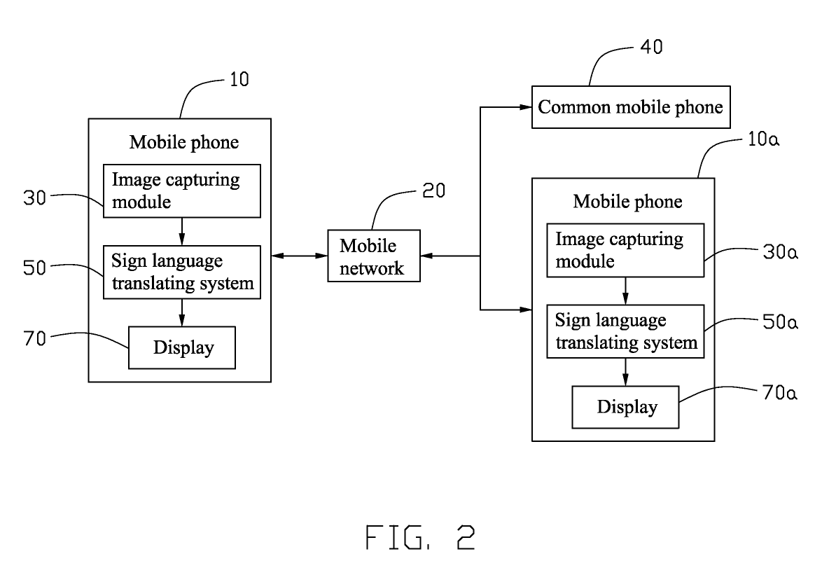

Referring to FIG. 2, the person using the mobile phone 10 can communicate with or send messages to others who are using a common mobile phone 40 or another person using a mobile phone 10a through a mobile network 20. The mobile phone 10a has the same functions with the mobile phone 10, and includes an image capturing module 30a, a sign language translating system 50a, and a display 70a.

When a person uses the mobile phone 10 for communicating with or sending messages using sign language, the image capturing module 30 of the mobile phone 10 will capture images of the person signing and transmit the images to the sign language translating system 50. The image analyzing module 531 of the sign language translating system 50 analyzes the captured sign language image utilizing image recognition technology, and then transmits it to the image encoding module 532. The image encoding module 532 encodes the analyzed sign language image to generate a series of image codes, and then transmits the image codes to the code analyzing module 533. The code analyzing module 533 searches the corresponding data codes of the image codes in the code database 535. If the user is using a message sending function, the code analyzing module 533 will transmit the corresponding text codes of the image codes to the code transforming and data transmitting module 534. If the user is using a voice transmitting function, the code analyzing module 533 will transmit the corresponding speech codes of the image codes to the code transforming and data transmitting module 534. The code transforming and data transmitting module 534 transforms the text or speech codes to the text or speech data, and transmits to the common mobile phone 40. When the common mobile phone 40 transmits text or speech data from a user to the person using the mobile phone 10, the text or speech data from the common mobile phone 40 will be transmitted to the sign language translating system 50 of the mobile phone 10. The data receiving and transforming module 511 of the sign language translating system 50 transforms the text or speech data to the corresponding image codes, and then transmits the image codes to the image analyzing module 512. The image analyzing module 512 searches for the corresponding sign language images of the image codes in the image database 513, and then displays those images on the display 70.

When a person signs using the mobile phone 10 for communicating with or sending messages to another person who wants to use sign language as well and is using the same type of mobile phone such as the mobile phone 10a, the image capturing module 30 of the mobile phone 10 captures images of the person using sign language and transmits those images to the sign language translating system 50. The image analyzing module 531 of the sign language translating system 50 analyzes the images using image recognition technology, and then transmits the results of the analysis to the image encoding module 532. The image encoding module 532 encodes the results to generate a series of image codes, and then transmits the image codes to the code analyzing module 533. The code analyzing module 533 searches the corresponding text or speech codes of the image codes in the code database 535, and then transmits to the corresponding codes to the code transforming and data transmitting module 534. The code transforming and data transmitting module 534 transforms the text or speech codes to the text or speech data, and transmits the text or speech data to the sign language translating system 50a of the mobile phone 10a. The data receiving and transforming module of the sign language translating system 50a receives and transforms the text or speech data to the corresponding image codes, and then transmits those codes to the image analyzing module. The image analyzing module searches the corresponding sign language images of the image codes in the image database, and then displays those images on the display 70a of the mobile phone 10a.

It is to be understood, however, that even though numerous characteristics and advantages of the embodiments have been set forth in the foregoing description, together with details of the structure and function of the invention, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A mobile phone comprising:
a display;
an image capturing module configured to capture images of a user communicating with sign language; and
a sign language translating system connected to the image capturing module, the sign language translating system comprising a data input module and a data output module;
wherein the data input module is configured to receive and transform a text data or a speech data to a corresponding sign language image, and display the sign language image on the display; the data output module is configured to receive and transform a sign language image captured by the data capturing module to a corresponding text data or a corresponding speech data.

2. The mobile phone of claim 1, wherein the data output module comprises an image analyzing module connected to the image capturing module, an image encoding module connected to the image analyzing module, a code analyzing module connected to the image encoding module, a code transforming and data transmitting module connected to the code analyzing module, and a code database connected to the code analyzing module.

3. The mobile phone of claim 2, wherein a plurality of text codes, a plurality of speech codes, and a plurality of image codes associated with the text and speech codes are stored in the code database.

4. The mobile phone of claim 3, wherein the image analyzing module is configured to analyze the sign language image captured by the data capturing module, the image encoding module is configured to encode the analyzed image to generate a series of image codes, the code analyzing module is configured to search for the codes corresponding to the image codes in the code database, and the code transforming and data transmitting module is configured to transform the text codes to the text data and the speech codes to the speech data for transmission.

5. The mobile phone of claim 1, wherein the data input module comprises an image analyzing module connected to the display, a data receiving and transforming module connected to the image analyzing module, and an image database connected to the image analyzing module.

6. The mobile phone of claim 5, wherein a plurality of sign language images and a plurality of image codes corresponding to the sign language images are stored in the image database.

7. The mobile phone of claim 6, wherein the data receiving and transforming module is configured to receive and transform the data to a series of image codes, the image analyzing module is configured to search the sign language images corresponding to the image codes in the image database, and display the sign language images on the display.

8. A mobile phone, comprising:
a data input module configured to receive and transform a text data or a speech data to a corresponding sign language image, the data input module comprising an image analyzing module, a data receiving and transforming module connected to the image analyzing module, and an image database connected to the image analyzing module; and
a data output module configured to receive and transform a sign language image to a corresponding text data or a corresponding speech data, the data output module comprising an image analyzing module, an image encoding module connected to the image analyzing module, a code analyzing module connected to the image encoding module, a code transforming and data transmitting module connected to the code analyzing module, and a code database connected to the code analyzing module.

9. The mobile phone of claim 8, further comprising an image capturing module configured to capture a sign language image, and connected to the data output module.

10. The mobile phone of claim 8, wherein a plurality of text codes, a plurality of speech codes, and a plurality of image codes associated with the text and speech codes are stored in the code database.

11. The mobile phone of claim 10, wherein the image analyzing module is configured to analyze the sign language image captured by the data capturing module, the image encoding module is configured to encode the analyzed image to generate a series of image codes, the code analyzing module is configured to search for the codes corresponding to the image codes in the code database, the code transforming and data transmitting module is configured to transform the text codes to the text data or the speech codes to the speech data for transmission.

12. The mobile phone of claim 8, wherein a plurality of sign language images and a plurality of image codes corresponding to the sign language images are stored in the image database.

13. The mobile phone of claim 12, wherein the data receiving and transforming module is configured to receive and transform the data to a series of image codes, the image analyzing module is configured to search for the sign language images corresponding to the image codes, and display the sign language images on a display.
